(19) United States
(12) Patent Application Publication
(10) Pub. No.: US 2023/0175592 A1
(43) Pub. Date: Jun. 8, 2023

(54) SEALING SYSTEM FOR ROTARY SHAFT

(71) Applicant: Tamar (R.C.) Technologies Development Ltd., Omer (IL)

(72) Inventors: Vaitzman Cohen-Zada, Beer Sheva (IL); Nir Santo, Beer Sheva (IL)

(73) Assignee: Tamar (R.C.) Technologies Development Ltd., Omer (IL)

(21) Appl. No.: 18/077,537

(22) Filed: Dec. 8, 2022

Related U.S. Application Data
(60) Provisional application No. 63/287,178, filed on Dec. 8, 2021.

(51) Int. Cl. F16J 15/40

(52) U.S. Cl. CPC F16J 15/40

(57) ABSTRACT

A seal for a rotary shaft having a sleeve surrounding the rotary shaft that rotates with the shaft and a stationary housing surrounding the sleeve. One or more sealing rings reduce or prevent escape of working fluid in a gap from between the sleeve and the housing. An injection tube serves to introduce a sealant into the gap. Two confining rings affixed to the housing surround the sleeve that mate with circumferential grooves on an outer surface of the sleeve.

### PRIORITY INFORMATION

The present application claims priority from US Provisional Patent Application No: 63/287,178, filed on Dec. 8, 2021.

### FIELD OF THE INVENTION

The present invention relates to the field of sealing systems, and more particularly, to such systems for rotary shafts.

### BACKGROUND OF THE INVENTION

Many types of machines utilize a shaft that rotates in a stationary housing. Between the shaft and the housing is a narrow gap that is filled with a working fluid that acts as a lubricant between the rotating shaft and the stationary housing. Where the shaft exits the housing a seal is required in order to minimize, or prevent escape of the working fluid from the housing. The seals are affixed to either the exterior surface of the shaft or the interior surface of the housing. A gap of minimal width filled with working fluid, together with One or more seals allow the shaft to rotate inside the housing with minimal frictional resistance, while minimizing or preventing escape of the working field.

In one type of rotary seal, a sealant is injected through a so-called stuffing box into the gap between the shaft and the housing. The fluid is confined to a region of the annular gap by one or more ‘O’ rings or rope seals in the gap above and below the stuffing box. By maintaining the pressure of the sealant above the pressure of the working fluid, the sealant tends to trap the working fluid in the gap, and thus reduce or prevent escape of the working fluid from the gap. Typically such sealants are fabricated from a blend of synthetic fibers, lubricants and binding agents.

The pressure in the stuffing box needs to be sufficiently high to promote adhesion of the sealant onto the rotary shaft, and to retard infiltration of working fluid from the gap into the stuffing box. The sealant pressure may actually be slightly less than the working fluid pressure due to the surface tension of the sealant which causes the sealant to adhere to the shaft and retard infiltration of working fluid into the stuffing box.

The sealant exerts a torque on the shaft, so that as the pressure of the sealant within the stuffing box is increased, more work is required to rotate the shaft at a given rotational frequency. However, the frictional forces between the rotating shaft and the sealant erode the adhered sealant, reducing the pressure of the sealant within the stuffing box, and if the pressure drops below the pressure of the working fluid, the working fluid could escape out of the housing. An optimal sealant pressure is thus sought that is typically established empirically.

The sealant is generally introduced into the stuffing box under pressure by an injector through an aperture that can be sealed after injection. Additional sealant can be introduced to the stuffing box as required to maintain the sealant pressure at a desired level. International Patent Publication WO07099535A2 describes an apparatus in which the sealant pressure is maintained at a fixed level by means of a sealant injector coupled to a pressure gauge to inject sealant as required to maintain a desired sealant pressure.

To prevent the sealant from overheating, water cooling may be used, with water introduced into a chamber surrounding the gap.

In addition to the rotation, the rotary shaft tends to vibrate as well. Such vibrations tend to disrupt the adhesion between the drive shaft and sealant, causing cavities to form. In order to minimize vibrations and prevent lateral movement of the shaft in the housing, the shaft is provided with circumferential rings that are integral with the shaft and which mate with a circumferential groove in the inside surface of the housing.

### SUMMARY OF THE INVENTION

The present invention provides a seal for a rotary shaft. In one embodiment, the seal comprises a sleeve surrounding the rotary shaft that s with the shaft. The sleeve is surrounded by a stationary housing. Between the housing and the sleeve is a narrow gap that is filled with working fluid which functions primarily as a lubricant between the rotating sleeve and the stationary housing. Sealing rings are used to minimize or prevent leakage of the working fluid from the gap.

The rotary seal of the invention may include an injection tube located in the housing to introduce a sealant into the gap.

The additional rings two rings in the housing are held stationary in the housing by means of barbs that protrude into the rings. The inventors have found that the use of stationary rings, instead of rings that are integral with the sleeve and that would rotate with the sleeve, generates pressure on the sealing rings, an effect referred to as mechanical packing or compression packing, which improves the sealing effect of the sealing rings.

The rotary shaft seal may be provided with an air injection system that injects air into the working fluid in the gap. The inventors have found that injecting air into the working fluid adsorbs and dilutes any gaseous debris in the working fluid that may be generated during rotation of the shaft. The inventors have further fluid that injecting water into the gap removes particulate debris that limns in the gap during rotation of the shaft.

Thus, in one of its aspects, the present invention provides A seal for a rotary shaft comprising:
(a) a sleeve surrounding the rotary shaft configured to rotate with the shaft,
(b) a housing configured to surround the sleeve, there being a gap between the sleeve and the housing;
(c) one or more sealing rings configured to reduce or prevent working fluid in the gap from escaping from the gap;
(d) an injection tube configured to introduce a sealant into the gap;
(e) a first confining ring configured to surround the sleeve, the first confining ring being affixed to the housing, and further configured to mate with a first circumferential groove on an outer surface of the sleeve; and
(f) a second confining ring configured to surround the sleeve, the second confining ring being affixed to the housing, and further configured to mate with a second circumferential groove on an outer surface of the sleeve.

The seal of the invention the first and second confining rings may be configured to confine sealant in the gap to a region of the gap between the first and second confining rings. The first and second confining rings may be configured to reduce or prevent lateral movement of the shaft in the housing.

The seal according to claim 1 further comprising an S box.

The first confining ring and the second confining ring may be affixed in the housing by means of barbs that penetrate into one or more of the first confining ring and the second confining ring.

The seal may further comprise an S box, it which case, one or more of the first confining ring and the second confining ring may be affixed in the housing by means of barbs attached to the S box that penetrate into one or more of the first confining ring and the second confining ring.

The seal of the invention may further comprise an injection system configured to inject a gas, such as air, into the gap to remove gaseous debris from the gap. The seal of the invention may further comprise an injection system configured to inject a liquid, such as water, into the gap to remove particulate debris from the gap.

### BRIEF DESCRIPTION OF THE DRAWINGS

in order to understand the invention and to see how it may be carried out in practice, a preferred embodiment will now be described, by way of non-limiting example only, with reference to the accompanying drawings, in which:

FIG. 1 shows a longitudinal section of a seal for a rotary shaft in accordance with one embodiment of the invention; and

FIG. 2 shows the rotary shaft of FIG. 1 in a cut-away perspective view.

### DESCRIPTION OF THE INVENTION

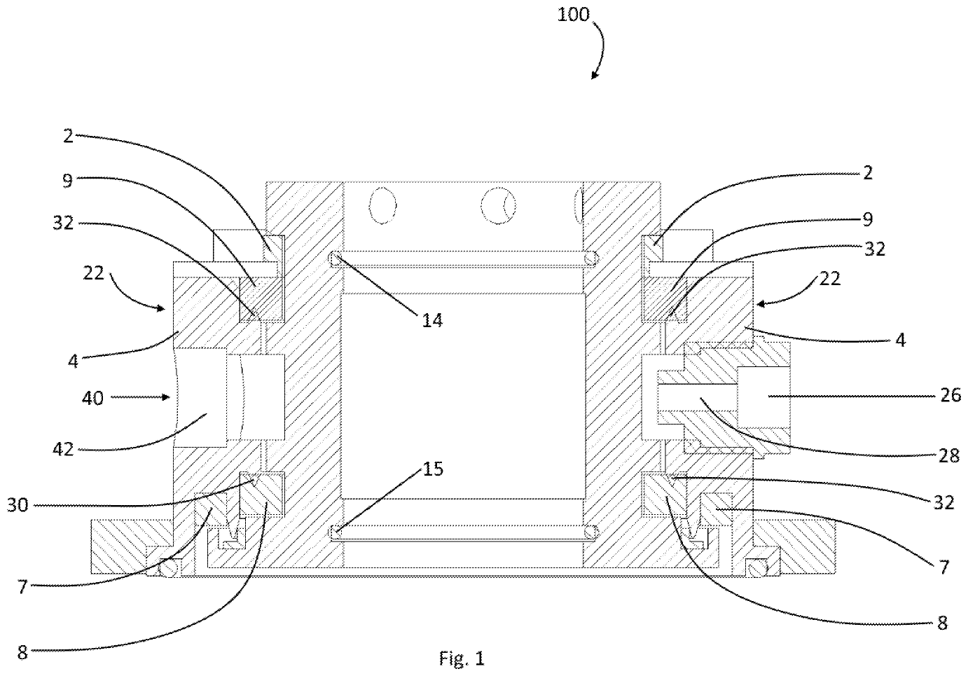

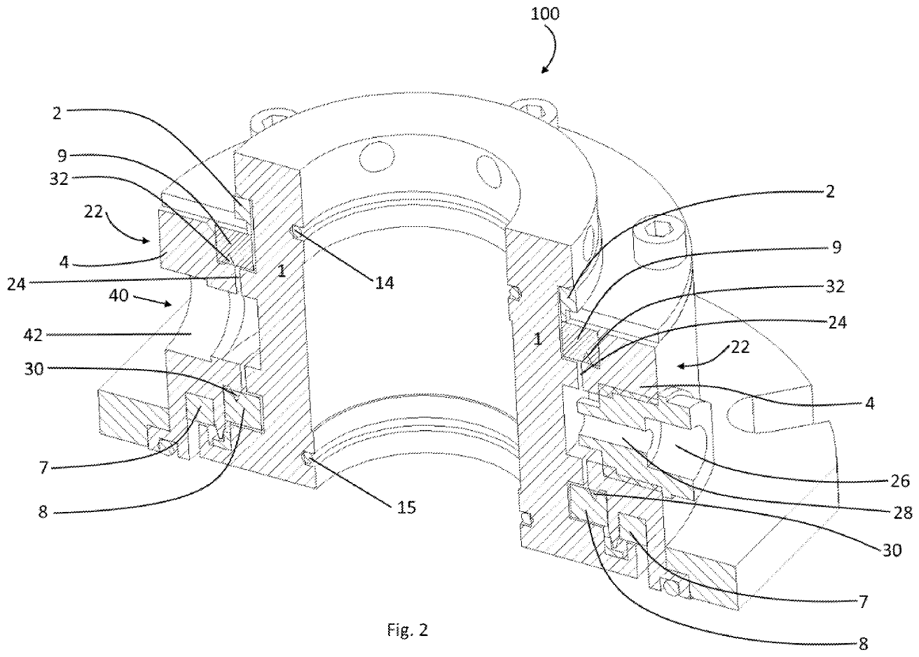

FIGS. 1 and 2 show a rotary shaft seal 100 in accordance with one embodiment of the invention. The rotary shaft seal 100 is shown in FIG. 1 in a longitudinal section and in FIG. 2 in a cut-away perspective showing the interior of the seal 100.

The seal 100 comprises a sleeve 1 that is configured to a surround a rotary shaft (not shown in FIGS. 1 and 2) and to rotate with the shaft. The sleeve 1 is surrounded by a stationary housing 22. Between the housing 22 and the sleeve 1 is a narrow gap 24 that is filled with working fluid which functions primarily as a lubricant between the rotating sleeve 1 and the stationary housing 22. Sealing rings 2 and 7 are used to minimize or prevent leakage of the working fluid from the gap 24. The sealing rings 2 and 7 may be made, for example, from Kevlar. RTM, graphite or Teflon. Fibrous o-rings of braided sealing can also be used.

An injection tube 26 located in the housing 22 is used to introduce a sealant into the gap 24 through a nozzle 28. Sealing rings 8 and 9 confine the sealant to a region of the gap 24 between the sealing rings 8 and 9.

The sleeve 1 is not provided with circumferential rings to minimize vibration and sliding of the shaft inside the housing 22. Instead, the two rings 8 and 9 in the housing 22 mate with grooves on the outer surface of the sleeve 1. The ring 8 is held stationary in the housing 22 by means of barbs 30 that protrude from an S box 4 into the ring 8. The ring 9 is held stationary in the housing 22 by means of other barbs 32 that protrude from the S box 4 into the ring 9, The rings 8 and 9 may be made from the same material as the sleeve 1, for example, steel. The inventors have found that the use of stationary rings 8 and 9, instead of rings that are integral with the sleeve and that rotate with the sleeve generates pressure on the sealing rings, an effect referred to as mechanical packing or compression packing, which improves the sealing effect of the sealing rings.

The rotary shaft seal 1100 is further provided with an air injection system 40 that allows air to be injected into the working fluid in the gap 24. The air injection system 40 comprises a nozzle 42 that may be connected to a syringe loaded with air (not shown in the figures), The inventors have found that injecting air into the working fluid adsorbs and dilutes any gaseous debris in the working fluid that may be generated during rotation of the shaft. The inventors have further found that injecting water into the gap 24 removes particulate debris that forms in the gap 24 during rotation of the shaft.

1. A seal for a rotary shaft comprising:
(a) a sleeve surrounding the rotary shaft configured to rotate with the shaft.
(b) a housing configured to surround the sleeve, there being a gap between the sleeve and the housing;
(c) one or more sealing rings configured to reduce or prevent working fluid in the gap from escaping from the gap;
(d) an injection tube configured to introduce a sealant into the gap;
(e) a first confining ring configured to surround the sleeve, the first confining ring being affixed to the housing, and further configured to mate with a first circumferential groove on an outer surface of the sleeve; and
(f) a second confining ring configured to surround the sleeve, the second confining ring being affixed to the housing, and further configured to mate with a second circumferential groove on an outer surface of the sleeve.

2. The seal according to claim 1 wherein the first and second confining rings are configured to confine sealant in the gap to a region of the gap between the first and second confining rings.

3. The seal according to claim 1 wherein one or more of the first and second confining rings are configured to reduce or prevent lateral movement of the shaft in the housing.

4. The seal according to claim 1 further comprising an S box.

5. The seal according to claim 1 wherein one or more of the first confining ring and the second confining ring are affixed in the housing by means of barbs that penetrate into one or more of the first confining ring and the second confining ring.

6. The seal according to claim 5 wherein one or more of the first confining ring and the second confining ring are affixed in the housing by means of barbs attached to the S box that penetrate into one or more of the first confining ring and the second confining ring.

7. The seal according to claim 1 further comprising an injection system configured to inject a gas into the gap to remove gaseous debris from the gap.

8. The seal according to claim 7 wherein the injected gas is air.

9. The seal according to claim 1 further comprising an injection system configured to inject a liquid into the gap to remove particulate debris from the gap.

10. The seal according to claim 9 wherein the liquid is water.
